(19) United States
(12) Patent Application Publication
(10) Pub. No.: US 2015/0143012 A1
(43) Pub. Date: May 21, 2015

(54) METHOD FOR CONFIGURING MAXIMUM TRANSMISSION UNIT (MTU), TERMINAL AND USB DATA CARD

(71) Applicants: Yalong Peng, Shenzhen City (CN); Yadong Wang, Shenzhen City (CN)

(72) Inventors: Yalong Peng, Shenzhen City (CN); Yadong Wang, Shenzhen City (CN)

(73) Assignee: ZTE CORPORATION, Shenzhen City, Guangdong (CN)

(21) Appl. No.: 14/400,364

(22) PCT Filed: Jun. 11, 2012
(86) PCT No.: PCT/CN2012/076704

§ 371 Date: Nov. 11, 2014

(30) Foreign Application Priority Data
May 11, 2012 (CN) 201210147275.9

(51) Int. Cl. G06F 11/22; G06F 13/40

(52) U.S. Cl. CPC G06F 11/2289; G06F 13/4068
USPC 710/301

(57) ABSTRACT

A method for configuring a maximum transmission unit (MTU) value, a terminal and a universal serial bus (USB) data card are provided. The method includes the following steps: after detecting that a connection to a USB data card is established (201), the terminal issuing a request for obtaining an MTU value to the USB data card (202); and after receiving the request, the USB data card writing the MTU value into a local registry (204). After the method is adopted, and after a USB data card connects to a computer, the computer can automatically obtain the MTU value from the USB data card, and automatically configures the value to a user registry, thereby achieving the effect that the data throughput is optimum when accessing under a specific network.

### TECHNICAL FIELD

The present invention relates to the embedded development field and the communication field, and in particular, to a method for configuring a maximum transmission unit (MTU) value and a corresponding apparatus.

### BACKGROUND OF THE RELATED ART

With the popularization of the 3rd generation mobile communication technology (3G) and the 4^{th} generation mobile communication technology (4G) networks, the universal serial bus (USB) data card products are getting more and more. However, since the MTU values of the gateways of different operators are set differently, thus it will result in that the ideal throughput can not be achieved when the user uses the data card products. Therefore, how to make the data card automatically configure the MTU value on the PC currently accessed by itself becomes a problem to be solved.

The existing method for configuring the MTU value through the data card currently is that: a configurable interface is provided on a User Interface (UI), the user finally writes the MTU value in a background file of the PC by inputting the specific MTU value in the configuration interface, and uses the MTU value to execute an action of dial-up connection.

With this method, the user using the terminal needs to know the MTU value of a current operator gateway. While for general users, it is unable to determine what a gateway MTU value of the current network needs to be set to reach an ideal result. Therefore, that function does not have a great use value for normal users, and it cannot achieve the purpose of improving the user experience.

### SUMMARY OF THE INVENTION

The objective of the embodiment of the present invention is to provide a method for configuring an MTU value and a corresponding apparatus, to overcome a disadvantage of requiring a user to configure the MTU value manually currently.

In order to solve the above-mentioned problem, the embodiment of the present invention provides a method for automatically configuring a maximum transmission unit (MTU) value at a terminal side, comprising:

after detecting that a connection to a universal serial bus (USB) data card is established, the terminal issuing a request for obtaining an MTU value to the USB data card;

after receiving the request, the USB data card sending a preconfigured MTU value to the terminal; and

after receiving the MTU value, the terminal writing the MTU value into a local registry.

Alternatively, the MTU value comprises an MTU value of a network card device and/or an MTU value of a modem.

Alternatively, the preconfigured MTU value in the USB data card is preset in the USB data card before the USB data card leaves a factory.

Accordingly, the embodiment of the present invention provides a terminal, accessing Internet through a universal serial bus (USB) data card after connecting to the USB data card, and comprising: a maximum transmission unit (MTU) automatic configuration module and an MTU request response module, wherein:

the MTU request response module is configured to: in an enumeration process of the USB data card, issue a request for obtaining an MTU value to the USB data card; and send an MTU value received from the USB data card side to the MTU automatic configuration module; and

the MTU automatic configuration module is configured to: write the MTU value obtained from the MTU request response module into a user registry.

Alternatively, the MTU value comprises an MTU value of a network card device and/or an MTU value of a modem.

Accordingly, the embodiment of the present invention further provides a universal serial bus (USB) data card, through which a terminal accesses Internet after a connection to the terminal is established, comprising:

a maximum transmission unit (MTU) configuration module, configured to: store a preconfigured MTU value; and

an MTU response module, configured to: after receiving a request for obtaining an MTU value issued by the terminal connected to the USB data card, send the MTU value stored in the MTU configuration module to the terminal.

Alternatively, the MTU value comprises an MTU value of a network card device and/or an MTU value of a modem.

Alternatively, the MTU configuration module is further configured to provide an interface for a user to configure the MTU value.

After the scheme of the embodiment of the present invention is adopted, and after the USB data card connects to a computer, the PC will automatically obtain the MTU value from the USB data card, and automatically configure the value into the user registry, thereby achieving an effect that the data throughput is optimum when accessing under a specific network. For a common terminal user, it can improve the use efficiency of the USB data card greatly.

### BRIEF DESCRIPTION OF DRAWINGS

FIG. 1 (a) is a structure diagram of a terminal according to an embodiment of the present invention;

FIG. 1 (b) is a structure diagram of a USB data card according to an embodiment of the present invention;

FIG. 2 is a flow chart of a method for automatically configuring an MTU value at a terminal side according to an embodiment of the present invention.

### PREFERRED EMBODIMENTS OF THE INVENTION

The embodiment of the present invention is described in detail with reference to the accompanying drawings hereinafter. It should be illustrated that, in the case of not conflicting, the embodiments in the present application and features in these embodiments can be combined with each other arbitrarily.

In the present embodiment, a method for automatically configuring an MTU value at a terminal side is provided. The terminal can access the Internet through the data card after connecting to the USB data card. And the method includes the following steps.

In step 10, after detecting that a connection to the USB data card is established, the terminal issues a request for obtaining the MTU value to the USB data card.

In step 20, after receiving the request, the USB data card sends a preconfigured MTU value to the terminal; wherein, the MTU value can be an optimum MTU value set for the operator gateway of the place of sale by the manufacturer before the USB data card leaves a factory, and the user also can modify that preconfigured value subsequently through a reserved operation interface; in addition, the MTU value can include an MTU value of a network card device and/or an MTU value of a modem.

In step 30, after receiving the above-mentioned MTU value, the terminal can write the obtained MTU value into a registry of the terminal. Later, a good data throughput can be achieved after the link is established successfully.

In sum, the above-mentioned method is realized through the manufacturer drive preinstalled in the user terminal, during the enumeration process of the USB device, automatically configuring the MTU value obtained from the USB data card to the user registry.

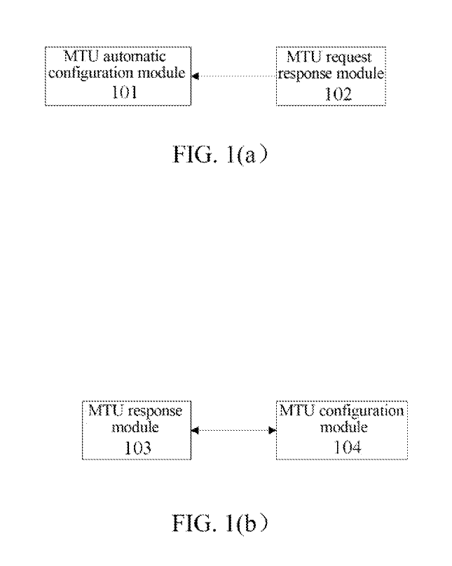

Accordingly, the above-mentioned method can be applied to the system including the USB data card and the terminal, as shown in FIG. 1 (a), and the terminal side includes the following modules:

an MTU automatic configuration module 101, configured to write the MTU value obtained from the MTU request response module 102 to a user registry, thus achieving the optimal data throughput when the user dials up for connecting to the Internet; and

an MTU request response module 102, configured to, in an enumeration process of the USB data card, issue a request for obtaining the MTU value to the USB data card; and parse the response message when receiving the response message sent by the USB data card side, and send the parsed-out MTU value to the MTU automatic configuration module 101.

As shown in FIG. 1 (b), the USB data card side includes the following modules:

an MTU response module 103, configured to, after receiving a request for obtaining the MTU value issued by the terminal connected to itself, send the MTU configured by the MTU configuration module 104 to the above-mentioned terminal;

an MTU configuration module 104, configured to store the optimal MTU value for the special operator preconfigured in the USB data card before the USB data card leaves a factory; and also to be able to provide an interface for the user to configure the MTU value.

Generally speaking, the above-mentioned USB data card and terminal may also need to include other working modules under the normal working state, but this is not clearly indicated in the present embodiment.

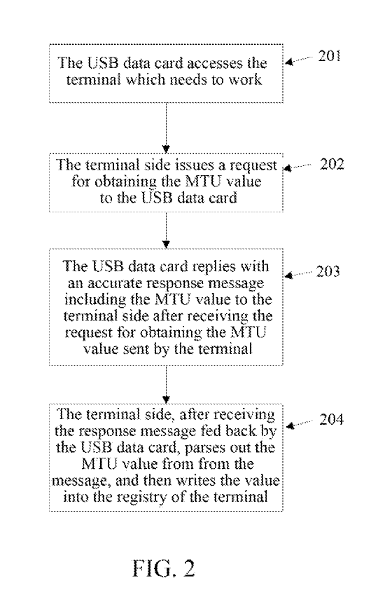

Referring to FIG. 2, the step that the embodiment of the present invention utilizes the terminal drive and the USB data card which work together, thus achieving automatically modifying the user MTU value, is explained in detail hereinafter.

As shown in FIG. 2, the method for automatic configuring the MTU value at the terminal side includes the following steps.

In step 201, the USB data card accesses the terminal which needs to work.

The USB data card is a device including the function modules 103 and 104 in FIG. 1 (b). The terminal is a personal computer preinstalled with the manufacturer drive, and also can be other devices supporting the USB master controller (including the function modules 101 and 102), such as, the palmtop computer, etc. In the present example, the operating system running on the host computer is windows. In fact, it can be another operating system, for example, the operating systems such as win7, windows vista, etc., which will not be limited in the present example.

In step 202, the terminal side issues a request for obtaining the MTU value to the USB data card.

In step 203, the USB data card replies with an accurate response message including the MTU value to the terminal side after receiving the request for obtaining the MTU value sent by the terminal.

In step 204, the terminal side, after receiving the response message fed back by the terminal side, parses out the MTU value (including the MTU value of the network card and the modem) from the message, and then writes the value into the registry of the terminal.

It can be understood by those skilled in the art that all or part of steps in the above-mentioned method can be fulfilled by programs instructing the relevant hardware components, and the programs can be stored in a computer readable storage medium such as a read only memory, a magnetic disk or an optical disk, etc. Alternatively, all or part of the steps in the above-mentioned embodiments can be implemented with one or more integrated circuits. Accordingly, each module/unit in the above-mentioned embodiments can be implemented in the form of hardware, or in the form of software function module. The present invention is not limit to any specific form of the combination of the hardware and software.

The above description is only for the preferred embodiments of the present invention and is not intended to limit the protection scope of the present invention. The present invention can have a variety of other embodiments according to the summary of the present invention. Those skilled in the art can make various modifications and changes according to the present invention without departing from the spirit and essence of the present invention. All of modifications, equivalents and/or changes made within the spirit and rule of the present invention should be embodied in the scope of the appended claims of the present invention.

### INDUSTRIAL APPLICABILITY

After the scheme of the embodiment of the present invention is adopted, and after the USB data card connects to the computer, the PC will automatically obtain the MTU value from the USB data card, and automatically configures the value to the user registry, thereby achieving an effect that the data throughput is optimum when accessing under a specific network. For a common terminal user, it can improve the use efficiency of the USB data card greatly.

1. A method for configuring a maximum transmission unit (MTU) value, comprising:
after detecting that a connection to a universal serial bus (USB) data card is established, the terminal issuing a request for obtaining an MTU value to the USB data card; and
after receiving a preconfigured MTU value from the USB data card, the terminal writing the MTU value into a local registry.

2. The method according to claim 1, wherein:
the MTU value comprises an MTU value of a network card device and/or an MTU value of a modem.

3. The method according to claim 1, wherein:
the preconfigured MTU value in the USB data card is preset in the USB data card before the USB data card leaves a factory.

4. A terminal for accessing Internet through a universal serial bus (USB) data card after connecting to the USB data card, the terminal comprising: a maximum transmission unit (MTU) automatic configuration module and an MTU request response module, wherein:
the MTU request response module is configured to: in an enumeration process of the USB data card, issue a request for obtaining an MTU value to the USB data card; and send an MTU value received from the USB data card side to the MTU automatic configuration module; and
the MTU automatic configuration module is configured to: write the MTU value obtained from the MTU request response module into a user registry.

5. The terminal according to claim 4, wherein:
the MTU value comprises an MTU value of a network card device and/or an MTU value of a modem.

6. A universal serial bus (USB) data card, through which a terminal accesses Internet after a connection to the terminal is established, comprising:
a maximum transmission unit (MTU) configuration module, configured to: store a preconfigured MTU value; and
an MTU response module, configured to: after receiving a request for obtaining an MTU value issued by the terminal connected to the USB data card, send the MTU value stored in the MTU configuration module to the terminal.

7. The USB data card according to claim 6, wherein:
the MTU value comprises an MTU value of a network card device and/or an MTU value of a modem.

8. The USB data card according to claim 6, wherein:
the MTU configuration module is further configured to provide an interface for a user to configure the MTU value.

9. The method according to claim 2, wherein:
the preconfigured MTU value in the USB data card is preset in the USB data card before the USB data card leaves a factory.

10. The USB data card according to claim 7, wherein:
the MTU configuration module is further configured to provide an interface for a user to configure the MTU value.
